(19) United States
(12) Patent Application Publication
(10) Pub. No.: US 2023/0366486 A1
(43) Pub. Date: Nov. 16, 2023

(54) METHOD FOR RETRIEVING A PIPELINE

(71) Applicant: Darren O'LEARY, Floreat (AU)

(72) Inventor: Darren O'LEARY, Floreat (AU)

(21) Appl. No.: 18/245,342

(22) PCT Filed: Sep. 16, 2021
(86) PCT No.: PCT/AU2021/051066

§ 371 Date: Mar. 14, 2023

(30) Foreign Application Priority Data
Sep. 19, 2020 (AU) 2020903362

(51) Int. Cl. F16L 1/16; F16L 1/23; F16L 1/20

(52) U.S. Cl. CPC F16L 1/166; F16L 1/23; F16L 1/207

(57) ABSTRACT

A method for retrieving a pipeline from a seabed in the body of water to a vessel includes the steps of suspending at least a portion of the pipeline in the body of water between the seabed and the vessel, plastically deforming the portion of the pipeline to form a plastically deformed portion, and retrieving the plastically deformed portion to the vessel.

### CROSS REFERENCE TO RELATED APPLICATIONS

The present application is a § 371 national stage of International ApplicationPCT/AU2021/051066, filed Sep. 16, 2021, which claims priority benefit of Australian Pat. Application AU2020903362, filed Sep. 19, 2020.

### FIELD OF THE INVENTION

This invention relates generally to pipeline retrieval, and more particularly to pipeline retrieval methods that can be carried out subsea more efficiently than existing methods. The present invention also relates to a system for retrieving a pipeline.

### BACKGROUND OF THE INVENTION

There are many subsea pipelines that have either already come to the end of their useful life or will do so in the near term. Once abandoned, pipelines are flushed & filled with treated water. Over time it is common for heavy metals and other toxins leach into the in-pipe water.

In terms of decommissioning a pipeline the options include:
a) leaving the pipeline in-situ with minor corrective measures;
b) leaving the pipeline in-situ with major corrective measures; and
c) removing/retrieving the pipeline, often also reinstating the seabed, and taking the pipeline to shore for reuse/scrapping.

To date, option a) and b) are by far the most common. Option c) is probably the most desirable, at least from an environmental point of view, but it is the least commercially attractive due to higher costs.

In terms of removing/retrieving pipelines prior art methods typically involve methods that correspond to the reverse of the original installation process such S-Lay. J-Lay or Reel-Lay, termed Reverse S-Lay. Reverse J-Lay and Reverse Reel-Lay. When applying such prior art retrieval methods upward pressure is placed on costs due to the need to use expensive assets, such as large barges or vessels, that have the capacity to apply the high tensions and/or thrusts required to retrieve the pipelines. In this regard, the pipelines are often very heavy, particularly when wet (e.g. filled with treated water) and the objective is often to avoid altering the shape and/or structural integrity of the pipeline during the retrieval process.

The present invention seeks to provide an improved method for retrieving a pipeline and a system for retrieving a pipeline that addresses or at least partially ameliorates the problems with existing methods and apparatus. At the very least, the present invention seeks to provide a method and system that is a useful alternative to currently available methods and systems.

### SUMMARY OF THE INVENTION

The present invention provides a method and a system for retrieving a pipeline onto a mobile vessel from the bottom of the ocean floor.

According to a first aspect, the present invention provides a method for retrieving a pipeline from a seabed in a body of water to a topside location, the method comprising the steps:
(a) suspending at least a portion of the pipeline in the body of water between the seabed and the topside location;
(b) plastically deforming said portion of the pipeline to form a plastically deformed portion, and
(c) retrieving said plastically deformed portion to the topside location.

According to a second aspect of the present invention there is provided a system for managing a plastically deformed pipeline that has been retrieved from a body of water, the system comprising:
(a) a means for straightening the plastically deformed pipeline to form a straightened pipeline, and
(b) a means for applying longitudinal tension to the straightened pipeline; wherein (a) and (b) are located in a series and (a) is positioned before (b) in the series.

According to a first aspect, the present invention provides a method for retrieving a pipeline from a seabed in a body of water to a topside location, the method comprising the steps:
(a) suspending at least a portion of the pipeline in the body of water between the seabed and the topside location;
(b) plastically deforming said portion of the pipeline to form a plastically deformed portion; and
(c) retrieving said plastically deformed portion to the topside location.

Applicant has developed a method that is opposed to and counterintuitive to existing pipeline retrieval methods that apply pipeline installation methods, in reverse, and seek to avoid plastic deformation of the pipeline during retrieval. Surprisingly, Applicant has determined that subsea pipelines can be retrieved effectively and more efficiently using methods where the subsea pipeline is allowed to plastically deform. Such methods allow the application of relatively low longitudinal tensions to a given pipeline during retrieval, compared to existing methods.

As used herein the term “plastic deformation” (and variants thereof such as “plastically deforming” and “plastically deform”) refers to a distortion that occurs when the pipeline or portion thereof is subjected to tensile, compressive, bending, or torsion stresses that exceed its yield strength and cause it to elongate, compress, buckle, bend and/or twist.

Preferably, the plastic deformation is achieved by subjecting the pipeline to a controlled and predetermined amount of longitudinal tension.

The pipeline may be coated. In this regard, the pipeline may comprise a concrete coating, reinforced concrete coating or steel reinforced concrete coating. The pipeline may also comprise another coating selected from the list of coatings consisting of: plastic coatings such as, polyethylene, polypropylene PPL and epoxy e.g., fusion bonded epoxy (FBE).

Preferably, the pipeline includes a fluid. In this regard, the pipeline may be a “wet” pipeline.

Preferably, the pipeline is sealed at one or both of its ends. Even more preferably, the pipeline includes a capping or plugging member at each end.

Preferably the body of water has a depth of 5-1000 m, 50-900 m, 100-800 m, up to 50 m, up to 80 m or up to 160 m.

Preferably, the topside location is adapted to move and even more preferably is self-propelled Preferably, the topside location comprises a vessel. Suitable vessels include: construction support vessels, floating barges, vessels with long open decks and cranes), vessels adapted to perform pipelaying and vessels already built for pipelaying.

Preferably, the vessel is adapted for dynamic positioning. The topside location may also be a platform or some other similar fixed structure.

Preferably, the vessel is adapted to provide forward thrust. This can be by pulling on anchor wires or using dynamic positioning (DP) thrusters. Importantly, the invention requires much lower forward thrust loads than traditional approaches. The required tension can be from 10 Te to up to 150 Te, depending on the pipeline properties and water depth. Examples include up to 20 Te, 30 Te, 40 Te, 50 Te, 60 Te, 75 Te, 80 Te, 90 Te, 100 Te or 150 Te.

Preferably, the step of suspending at least a portion of the pipeline comprises the application of a first longitudinal tension to the pipeline.

The greater the depth of the body of water and/or the pipeline diameter, the greater the mass of pipeline that needs to be suspended and hence the higher the first longitudinal tension. Preferably, the first longitudinal tension is up to 20 Te, 30 Te, 40 Te, 50 Te, 60 Te, 75 Te, 80 Te, 90 Te, 100 Te or 150 Te, Preferably, said first longitudinal tension is provided by a vessel attached to the pipeline. Preferably, the vessel provides the first longitudinal tension by the application of thrust.

The vessel may be attached directly to the pipeline or attached to the pipeline via an intermediate line.

The first longitudinal tension may also be provided, at least in part, by a tensioner or some other similar apparatus.

The other similar apparatus may be one or a combination of a brake, a clamp and a winch.

Preferably, the step of suspending at least a portion of the pipeline comprises the formation of an overbend.

As used herein the term “overbend” refers to a curved section of pipeline above the point of inflection in the pipeline.

Preferably, the step of suspending at least a portion of the pipeline comprises the formation of a sagbend.

As used herein the term “sagbend” refers to a curved section of pipeline below the point of inflection in the pipeline.

Preferably, the step of suspending a portion of the pipeline comprises the formation of a sagbend and an overbend.

Preferably, the portion of the pipeline that is suspended comprises a mass, such as net submerged mass of 20 kg/m to 900 kg/m 20 kg/m to 500 kg/m, 50 kg/m-400 kg/m, 100 kg/m-300 kg/m.

Preferably, the portion of the pipeline that is suspended comprises a length of 50 to 500 m, 20-300 m, 100-400 m, 200-300 m.

Preferably, the step of plastically deforming said portion of the pipeline comprises the application of a second longitudinal tension to the pipeline.

Preferably, the second longitudinal tension is sufficient to allow plastic deformation of the pipeline that results in up to 7.5%, 5%, 4%, 3.5%, 3%, 2.5%, 2%, 1.5%, 1%, 0.9%, 0.8% ovality measured by finite element analysis or analytically.

Preferably, the second longitudinal tension is sufficient to allow plastic deformation of the pipeline that results in up to 1%, 0.9%, 0.8%, 0.7%, 0.6%, 0.5%, 0.4%, 0.35%, 0.3%, 0.25%, 0.2%, 0.15% axial strain.

Preferably, the second longitudinal tension is up to 20 Te, 30 Te, 40 Te, 50 Te, 60 Te, 75 Te, 80 Te, 90 Te, 100 Te or 150 Te. The second longitudinal tension will be maintained at a target or predetermined longitudinal tension that allows for plastic deformation of the pipeline but not to a point where the level of plastic deformation becomes problematic in terms of further handling of the pipeline or causing the pipeline to rupture or break.

Preferably, the second longitudinal tension is provided by a vessel attached to the pipeline. Preferably, the vessel provides the second longitudinal tension by the application of thrust or by pulling against wires connected to seabed anchors.

The second longitudinal tension may also be provided, at least in part, by a tensioner or some other similar apparatus that clamps or otherwise secures the pipeline.

The radius of curvature of the plastically deformed portion will vary depending at least on pipe diameter. Preferably, the plastically deformed portion has a radius of curvature of about 30-100 m, 40-90 m or about 50 m.

Preferably, the plastically deformed portion is formed at, near or throughout an overbend in the pipeline preferably, the plastically deformed portion is formed at or near an extension that projects from the topside location. For example, when the topside location is a vessel the extension may be a stinger or an equivalent structure and the most plastically deformed portion may be formed at or just distal to the end of the stinger.

Preferably, the second longitudinal tension is equivalent to the first longitudinal tension.

Preferably, the plastically deformed portion has a length of about 30.40.50, 75, 100, 150, 200 or 250 m.

Preferably, the plastically deformed portion is retrieved through the use of one, two or more tensioners or similar apparatus.

The similar apparatus may be one or a combination of a brake, a clamp and a winch. Preferably, when the topside location is mobile, such as a vessel, the topside location moves backwards or astern during the retrieval process. Preferably, the movement astern is towards the distal end of the pipeline.

Preferably the method according to the first aspect of the present invention further comprises the step of straightening the plastically deformed portion from step (c).

The straightening can be achieved by any suitable straightening means. Examples include: a) one or more pairs of rollers, that are adjusted so that the lateral gap between them is slightly smaller than the outside diameter of the pipe passing through them, b) heating members and c) pressing members.

Preferably, the straightener is hydraulically driven.

Preferably, the straightener defines a straight pathway or conduit through which the plastically deformed portion passes to effect the straightening.

Preferably, the straightener is adapted to allow the pipeline to pass therethrough preferably, the straightener is adjustable to accommodate different diameter pipeline.

Preferably the method according to the first aspect of the present invention further comprises the step of cutting the pipeline into sections after it has been retrieved to the topside location.

Preferably, the sections are at 36, 48 or 60 m or 120, 160, 200 or 240 feet in length. Even more preferably, the sections are sized based on the location of the welded joints in the pipeline. Given that welded joints are usually every 12 m or 40 feet the length of the sections may be a multiple of 12 (for metres) and 40 (for feet).

Preferably, the method according to the first aspect of the present invention further comprises the step of removing fluid from the pipeline.

Preferably the step of removing fluid from the pipeline is carried out after it has been retrieved to the topside location.

Preferably, the fluid is captured in a reservoir located topside.

Preferably, the fluid is removed by opening a sealed end of the pipeline or by cutting the pipeline.

When there is insufficient friction at the seabed to maintain the first or second longitudinal tension and hence control the plastic deformation of the pipeline, the method further comprises the step of applying a third longitudinal tension to a distal end of the pipeline.

The third longitudinal tension may be applied by a vessel attached to the distal end of the pipeline. Preferably, the vessel provides the third longitudinal tension by the application of thrust.

Preferably, the topside location comprises a system for managing a plastically deformed pipeline that has been retrieved from a body of water. Thus, according to a second aspect of the present invention there is provided a system for managing a plastically deformed pipeline that has been retrieved from a body of water, the system comprising:
(a) a means for straightening the plastically deformed pipeline to form a straightened pipeline; and
(b) a means for applying longitudinal tension to the straightened pipeline; wherein (a) and (b) are located in a series and (a) is positioned before (b) in the series

Preferably, the means for straightening is selected from the list of apparatus comprising: a) one or more pairs of rollers, that are adjusted so that the lateral gap between them is slightly smaller than the outside diameter of the pipe passing through them, b) heating members and c) pressing members.

Preferable, the means for applying longitudinal tension is selected from the list of apparatus comprising a tensioner or some other similar apparatus that clamps or otherwise secures the pipeline.

Preferably, there means for applying longitudinal tension comprises a plurality of apparatus such as two.

Preferably the system further comprises a support member for controlling the deformation of the pipeline.

Preferable, the support member is located in series with (a) and (b) above and the support member is positioned before (a) in the series.

Preferably, the support member is a stinger, boom, frame or some other similar device.

Preferably, the system is adapted to be fitted or installed to a topside location such as a vessel and, more particularly, to the deck of a vessel.

When the system is adapted to be fitted to a vessel, the support member may extend rearwards from the stem of the vessel.

Preferable, the support member is configured and positioned to allow for plastic deformation of the pipeline, during use.

Preferably, the support member comprises a length of 15, 20, 25, 30, 40, 50.60 or 70 m or 25-70 m.

Preferably, the support member is oriented to form a departure angle of about 30, 35, 40, 42, 44 or 45° to the horizontal.

Advantages

Whilst not limited to the following, applicant believes the present invention may have a number of advantages including one or more of the following:
(i) it allows for the use of smaller and/or lower cost assets, such as vessels, to undertake pipeline retrievals:
(ii) it allows for a pipeline to be cut at the surface in much longer pipe sections than traditional vessels,
(iii) it allows for existing pipeline vessels to retrieve flooded pipe at much lower tensions;
iv) the relatively low longitudinal tension applied in the subject invention reduces or ameliorates problems associated with pipeline slippage during retrieval—such slippage is more common when higher tensions are applied and with coated pipelines that may have slippery surfaces;
(v) the relatively low longitudinal tension applied in the subject invention reduces or ameliorates problems associated with anchor drat or slippage during retrieval such slippage is more common when higher tensions are applied;
vi) the relatively low longitudinal tension applied in the subject invention reduces or ameliorates vessel thruster loads and extra fuel costs when higher tensions are applied;
(vii) the invention can be applied to coated pipelines such as concrete coated pipelines without unduly compromising the coating; and
(viii) even though the invention allows for plastic deformation of the pipeline it can still be used with pipelines with compromised or reduced, wall thickness improved.

General

Those skilled in the art will appreciate that the invention described herein is susceptible to variations and modifications other than those specifically described. The invention includes all such variation and modifications. The invention also includes all of the steps and features referred to or indicated in the specification, individually or collectively and any and all combinations or any two or more of the steps or features.

Each document, reference, patent application or patent cited in this text is expressly incorporated herein in their entirety by reference, which means that it should be read and considered by the reader as part of this text. That the document, reference, patent application or patent cited in this text is not repeated in this text is merely for reasons of conciseness None of the cited material or the information contained in that material should, however be understood to be common general knowledge.

The present invention is not to be limited in scope by any of the specific embodiments described herein. These embodiments are intended for the purpose of exemplification only. Functionally equivalent products and methods are clearly within the scope of the invention as described herein.

The invention described herein may include one or more range of values (e.g. size etc.). A range of values will be understood to include all values within the range, including the values defining the range, and values adjacent to the range which lead to the same or substantially the same outcome as the values immediately adjacent to that value which defines the boundary to the range.

Throughout this specification, unless the context requires otherwise, the word “comprise” or variations such as “comprises” or “comprising”, will be understood to imply the inclusion of a stated integer or group of integers but not the exclusion of any other integer or group of integers.

Other definitions for selected terms used herein may be found within the detailed description of the invention and apply throughout. Unless otherwise defined, all technical terms used herein have the same meaning as commonly understood to one of ordinary skill in the art to which the invention belongs.

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. In the various Figures the same reference numerals have been used to identify similar elements.

These and other objects, advantages and features of the invention will become apparent upon review of the following specification in conjunction with the drawings.

### BRIEF DESCRIPTION OF THE DRAWING

FIGS. 1A-1C are a schematic series of images to illustrate one embodiment of the method of the first aspect of the invention; and

FIG. 2 is a side view of a vessel including one embodiment of the system of the second aspect of the invention.

### DESCRIPTION OF THE PREFERRED EMBODIMENTS

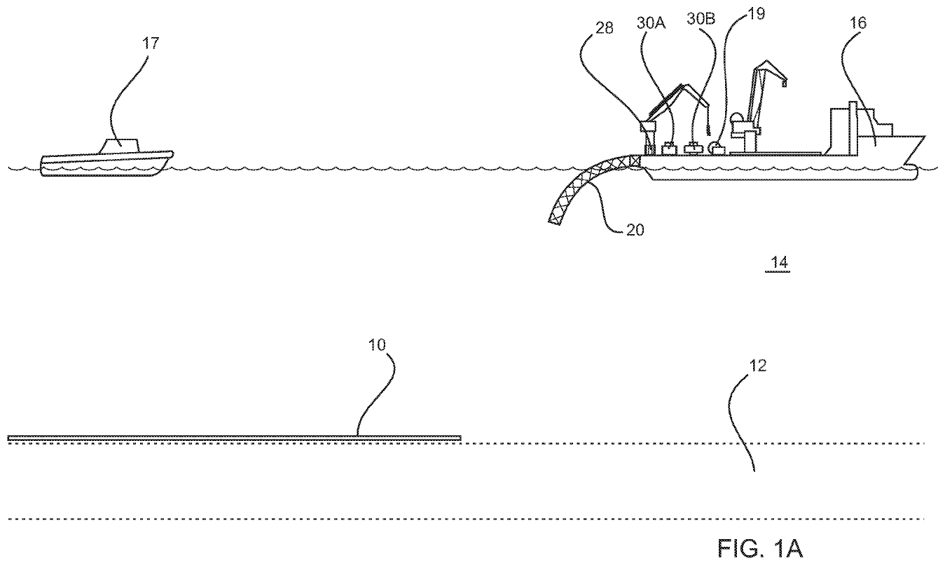

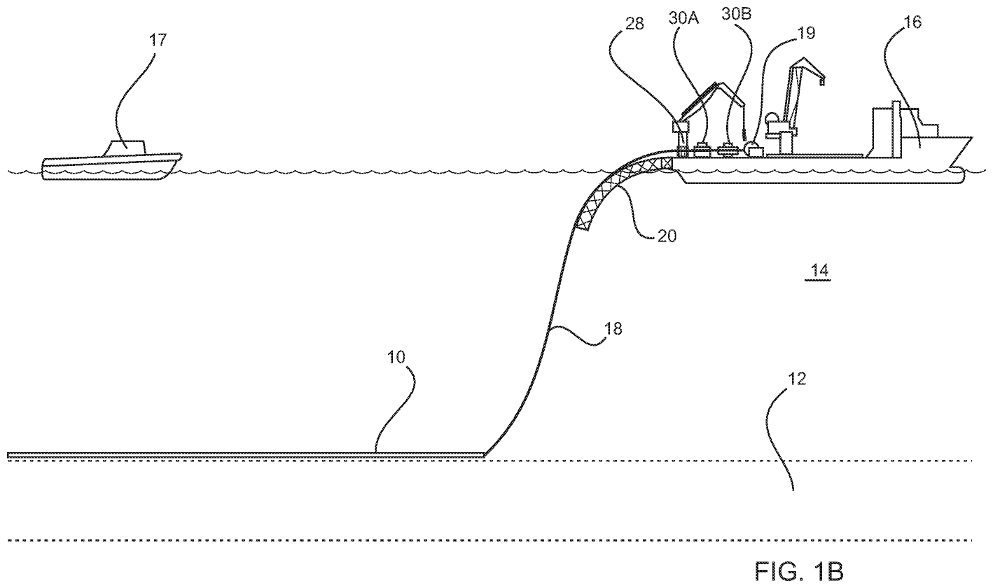

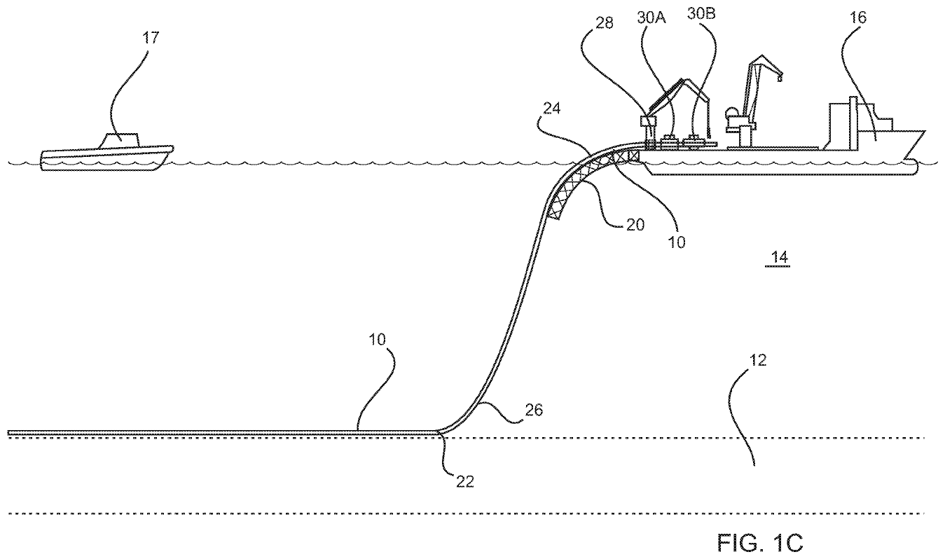

One embodiment of a first aspect of the present invention is depicted in FIG. 1A-1C, and comprises a method for retrieving a pipeline in the form of a subsea pipeline generally indicated by the numeral 10, from a seabed 12 in a body of water 14 to a topside location in the form of a dynamically positioned vessel 16.

FIG. 1A shows the method at a point where pre-operation site survey and preparation works have been completed at both ends of the pipeline 10. Both free ends of the pipeline 10 have been sealed with water tight closures, plugs or caps (not shown) to retain any fluid therein such as contaminated water. This sealing of the pipeline can be effected by ROV or some other suitable means. A topside location in the form of a vessel 16 is in position above the pipeline 10.

In FIG. 1B, the vessel 16 is shown still positioned at one end of the pipeline 10 and is set to hold a predetermined location via Dynamic Positioning (DP) Another vessel such as an Anchor Handling Tug (17), is positioned above the other end of the pipeline 10.

A first winch line IS extends from a winch 19 on the vessel 16 and is attached to the cap at one end of the pipeline 10.

Step (a) of the first aspect of the present invention is exemplified in FIG. 10 where, the winch 19 is actuated and winch line 18 retrieves the free end of the pipeline 10 to the vessel 16. As more of the pipeline 10 is suspended during the winching process (see FIG. 1B), the vessel 16 “takes up” the tension from the weight of the suspended pipeline 10. This is largely addressed by the vessel applying thrust to move astern via its DP, which ensures the vessel 16 applies a first longitudinal tension in the form of a predetermined longitudinal tension.

With respect to exemplifying step (b) of the first aspect of the present invention, in FIG. 10 the second longitudinal tension in the form of a predetermined longitudinal tension applied results in a suspended portion 22 of the subsea pipeline 10, that is unsupported and spans between a contact point 22 on the seabed 12 and the vessel 16, in this case, the distal end of a support member in the form of a stinger or chute 20. As a result, the pipeline 10 plastically deforms at or near and preferably over the entire overbend section 24 in the pipeline 10. It will be understood that this plastic deformation is a result of the relatively low tension applied to the pipeline 10 resulting in a tight radius of curvature of the pipeline 10, when compared to prior art retrieval methods based on the reverse of installation methods. A sagbend 26 in the pipeline 10 is also shown in FIG. 1C.

With respect to an example of step (c) of the method of the present invention, FIG. 10 also shows the pipeline 10, having been plastically deformed, being retrieved over the stinger 20 mounted on the vessel 16. While running over the stinger 20 the outside of the pipeline 10 is cleaned using a high-pressure water jet system or some other cleaning apparatus.

After leaving the stinger 20, the pipeline 10 is straightened, such as through the use of a straightener 28, which can be hydraulically actuated. The straightening process re-bends the plastically deformed pipeline 10 so that it is straight before contacting the tensioning means in the form of a series of two tensioners 30A, 30B that can retrieve the pipeline 10 along the full length of the deck of the vessel 16.

In an alternate embodiment of the invention, at least one of the two tensioners 30A. 30B could be replaced with a brake or clamping device that is capable of releasably holding the pipeline 10 on the deck of the vessel 16. When a brake or clamping device is included, a winch on the deck of the vessel 16 can be used to retrieve the pipeline 10 and the brake or clamping device can be used to hold the pipeline in position as required.

After being straightened, the retrieved pipeline may be further handled by any one or more of the following steps that seek to deal with any fluid contained within the pipeline:
(i) the pipeline may be cut, such as with shears, that may be supported from a crane on board vessel 16;
(ii) any caps on the ends of the pipeline may be removed; and
(iii) fluid from the pipeline can be drained to a reservoir and then pumped to other locations on the vessel 16 as required.

After being straightened and having any fluid therein removed, the pipeline cut into sections to ease further handling and storage aboard vessel 16.

When the amount of pipeline retrieved reaches the point where the amount of unretrieved pipeline is insufficient to provide the requisite amount of the third longitudinal tension, due essentially to insufficient friction between the unretrieved pipeline and the seabed 10, a line (not shown) from the tug 17 is attached to the distal end of the pipeline and thrust from tug 17 applies the requisite third longitudinal tension to allow the first and/or second longitudinal tension to be effectively applied and the pipeline 10 to be retrieved.

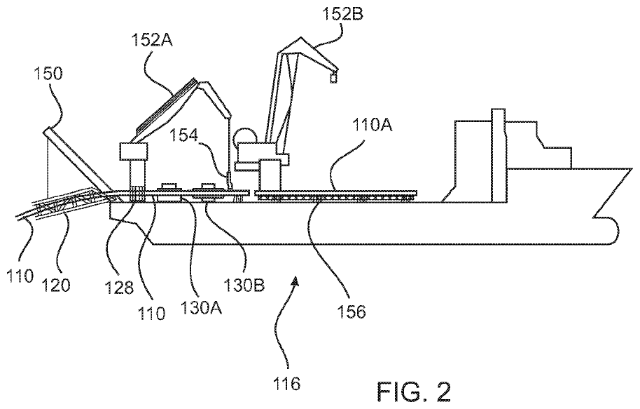

FIG. 2 depicts a system according to one embodiment of the second aspect of the present invention. The system for managing a plastically deformed pipeline is shown fitted to a vessel 116 with following general specifications DP Construction Support Vessel, with long deck of at least 50-100 m or 150 m. The system comprises a means for straightening the plastically deformed pipeline in the form of a hydraulic straightener 128 that is able to straighten pipe up to 36″ diameter that has had <0.4% strain and a means for applying longitudinal tension to the straightened pipeline in the form of first tensioner 130A with four tracks and capacity of 50 Te and second tensioner 130B with four tracks and capacity of 50 Te. The system allows for the pipeline to be straightened before engaging the tensioners 130A_130B.

The system also includes a support member for controlling the deformation of the pipeline in the form of stinger 120 which extends rearward and is supported from the stem of the vessel 116 by frame 150. The stinger 120 has a departure angle of about 30° to the horizontal, and allows for plastic deformation of the pipeline 110 and supports the plastically deformed pipeline 110 before it contacts the straightener 128 and tensioners 130A, 130B.

The system depicted in FIG. 2 includes additional components including, but not limited to:
(i) cable hoist 152A including cutting means in the form of a shear assembly 154 for cutting pipeline 110 into sections 110A after it has been straightened and passed tensioners 130A, 130B;
(ii) cable hoist 152B for lifting and moving the pipeline sections; and (iii) a work platform 156 for pipeline sections that may include rollers and other components to ease movement of the sections.

Below is an exemplary set of parameters that may be employed alone or in combination in the method or the system of the present invention:
(i) the mass of the portion of the pipeline suspended according to step (a) is 20 kg/m to 900 kg/m;
(ii) the length of the pipeline suspended according to step (a) is 20 m to 300 m; (iii) the plastically deformed portion has a an ovality of <3%;
(iv) the plastically deformed portion has an axial strain<0.4%;
(v) the support member has a length of 25-70 m;
(vi) the support member will have a radius of curvature of 30 m to 100 m.
(vii) the step of plastically deforming the pipeline will comprise the application of a first or second longitudinal tension of 20 Te-80 Te.

Changes and modifications in the specifically-described embodiments may be carried out without departing from the principles of the present invention, which is intended to be limited only by the scope of the appended claims as interpreted according to the principles of patent law including the doctrine of equivalents.

1. A method for retrieving a pipeline from a seabed in a body of water to a vessel, the method comprising:
(a) suspending at least a portion of the pipeline in the body of water between the seabed and the vessel;
(b) plastically deforming the portion of the pipeline to form a plastically deformed portion; and
(c) retrieving the plastically deformed portion onto the vessel.

2-4. (canceled)

5. The method according to claim 1, wherein the pipeline includes a fluid, and wherein the pipeline is sealed at one or both ends.

6-12. (canceled)

13. The method according to claim 1, wherein the step of suspending at least a portion of the pipeline includes applying a first longitudinal tension to the pipeline.

14. The method according to claim 13, wherein the first longitudinal tension is up to 150 Te, and wherein the first longitudinal tension is provided by the vessel connected to the pipeline.

15. (canceled)

16. The method according to claim 14, wherein the vessel provides the first longitudinal tension by applying a first thrust, and wherein the first longitudinal tension is provided at least partially by a tensioner or a combination of a brake, a clamp and a winch.

17. (canceled)

18. The method according to claim 1, wherein the step of suspending at least a portion of the pipeline includes forming of an overbend and a sag bend.

19-22. (canceled)

23. The method according to claim 13, wherein the step of plastically deforming the portion of the pipeline includes applying a second longitudinal tension to the pipeline.

24. The method according to claim 23, wherein the second longitudinal tension is sufficient to allow plastic deformation of the pipeline that results in no more than 7.5% ovality and no more than 1% axial strain, and wherein the second longitudinal tension is up to 150 Te.

25. (canceled)

26. (canceled)

27. The method according to claim 23, wherein the second longitudinal tension is provided by the vessel connected to one end of the pipeline, wherein the vessel provides the second longitudinal tension by applying a second thrust, and wherein the second longitudinal tension is provided at least partially by a tensioner or a combination of a brake, a clamp and a winch.

28. (canceled)

29. (canceled)

30. The method according to claim 1, wherein the plastically deformed portion has a radius of curvature of about 30 m, 50 m, 70 m, 90 m or 110 m, and wherein the plastically deformed portion is formed at or near an overbend in the pipeline.

31. (canceled)

32. The method according to claim 1, wherein the plastically deformed portion is formed at or near an extension that projects from the vessel, wherein the plastically deformed portion has a length of up to 250 m, and wherein the plastically deformed portion is retrieved via one or more tensioners or a combination of a brake, a clamp and a winch.

33-35. (canceled)

36. The method according to claim 1, the method further comprising:
straightening the plastically deformed portion after retrieving the plastically deformed portion to the vessel;
wherein the step of straightening includes passing the plastically deformed portion through a straightening mechanism to effectuate the straightening.

37. (canceled)

38. The method according to claim 36, the method further comprising:
cutting the pipeline into one or more sections after the pipeline was retrieved to the vessel.

39-42. (canceled)

43. The method according to 27, the method further comprising:
in response to an insufficient friction at the seabed to control the plastic deformation of the pipeline applying a third longitudinal tension to a distal end of the pipeline;
wherein the distal end is an opposite end of the one end of the pipeline connected to the vessel; and
wherein the third longitudinal tension is applied by a second vessel connected to the distal end of the pipeline.

44. (canceled)

45. A system for managing a plastically deformed pipeline that has been retrieved from a body of water, the system comprising
a means for straightening the plastically deformed pipeline to form a straightened pipeline, and
a means for applying a longitudinal tension to the straightened pipeline;
wherein the means for straightening is arranged in-line with and before the means for applying.

46. The system according to claim 45, wherein the means for straightening is selected from the group comprising of: a) one or more pairs of rollers that are adjusted so that a gap between the one or more rollers is smaller than an outside diameter of the pipeline passing through the one or more rollers, b) one or more heating members, and c) one or more pressing members.

47. The system according to claim 45, wherein the means for applying the longitudinal tension is selected from the group consisting of a tensioner that clamps or secures the pipeline or a brake or clamping device that is capable of releasably holding the pipeline.

48-50. (canceled)

51. The system according to claim 45 further comprising a support member for controlling a deformation of the pipeline, wherein the support member is a stinger, boom, frame or some other similar device.

52. The system according to claim 51, wherein the support member is arranged in-line with the means for straightening and the means for applying and before the means for straightening.

53. (canceled)

54-58. (canceled)
